(19) United States
(12) Patent Application Publication
(10) Pub. No.: US 2018/0163637 A1
(43) Pub. Date: Jun. 14, 2018

(54) FUEL SUPPLY SYSTEM

(71) Applicant: ROLLS-ROYCE PLC, London (GB)

(72) Inventor: Michael Griffiths, Derby (GB)

(73) Assignee: ROLLS-ROYCE PLC, London (GB)

(21) Appl. No.: 15/821,505

(22) Filed: Nov. 22, 2017

(30) Foreign Application Priority Data
Dec. 9, 2016 (GB) 1621008.0

(51) Int. Cl. F02C 9/26; F23R 3/34; F02C 7/22; F02C 7/232

(52) U.S. Cl. CPC F02C 9/263; F23R 3/346; F05D 2240/35; F02C 7/232; F05D 2220/32; F02C 7/222

(57) ABSTRACT

A fuel supply system includes a metering and splitting arrangement receiving a fuel flow and controllably meters and splits the received fuel flow into metered pilot and mains flows for injecting at injector pilot and mains fuel discharge orifices to perform combustor staging control. The system includes an ecology valve having a piston chamber and a piston slidably movable in the chamber between de-prime and re-prime positions, the chamber forming a fuel sink to one side of the piston which increases in volume when the piston moves to its de-prime position and reduces in volume when the piston moves to its re-prime position. The system includes an actuator for actuating the piston. The valve is fluidly connected to a mains fuel distribution for operating the piston to its de-prime position to remove the mains fuel from the injectors through the mains fuel distribution pipework and into the fuel sink.

### FIELD OF THE INVENTION

The present invention relates to a fuel supply system for fuel injectors of a multi-stage combustor of a gas turbine engine.

### BACKGROUND

Multi-stage combustors are used particularly in lean burn fuel systems of gas turbine engines to reduce unwanted emissions while maintaining thermal efficiency and flame stability. For example, duplex fuel injectors have pilot and mains fuel manifolds feeding pilot and mains discharge orifices of the injectors. At low power conditions only the pilot stage is activated, while at higher power conditions both pilot and mains stages are activated. The fuel for the manifolds typically derives from a pumped and metered supply. A splitter valve can then be provided to selectively split the metered supply between the manifolds as required for a given staging.

A typical annular combustor has a circumferential arrangement of fuel injectors, each associated with respective pilot and mains feeds extending from the circumferentially extending pilot and mains manifolds. Each injector generally has a nozzle forming the discharge orifices which discharge fuel into the combustion chamber of the combustor, a feed arm for the transport of fuel to the nozzle, and a head at the outside of the combustor at which the pilot and mains feeds enter the feed arm. Within the injectors, a check valve, known as a flow scheduling valve (FSV), is typically associated with each feed in order to retain a primed manifold when de-staged and at shut-down. The FSVs also prevent fuel flow into the injector nozzle when the supply pressure is less than the cracking pressure (i.e. less than a given difference between manifold pressure and combustor gas pressure).

Multi-stage combustors may have further stages and/or manifolds. For example, the pilot manifold may be split into two manifolds for lean blow-out prevention during rapid engine decelerations.

During pilot-only operation, the splitter valve directs fuel for burner flow only through the pilot fuel circuit (i.e. pilot manifold and feeds). It is therefore conventional to control temperatures in the de-staged (i.e. mains) fuel circuit to prevent coking due to heat pick up from the hot engine casing. One known approach, for example, is to provide a separate recirculation manifold which is used to keep the fuel in the mains manifold cool when it is deselected. It does this by keeping the fuel in the mains manifold moving, although a cooling flow also has to be maintained in the recirculation manifold during mains operation to avoid coking.

FIG. 1 shows schematically a combustion staging system 130 for a gas turbine engine. A metered fuel flow arrives at the staging system at a pressure P_{fmu}. The staging system splits the fuel into two flows: one at a pressure Pₚ for first 131a and second 131b segments of a pilot manifold and the other at a pressure Pₘ for a mains manifold 132. Fuel injectors 133 of a combustor of the engine are split into two groups. The injectors of one group are connected to the first pilot manifold segment 131a, while the injectors of the other group are connected to the second pilot manifold segment 131b. The mains manifold feeds secondary discharge orifices of the fuel injectors. Pilot FSVs 139 and mains FSVs 140 at the injectors prevent fuel flow into the injectors when the pressure difference between the upstream manifold and the downstream combustion chamber is below the cracking point of the valve (i.e. at conditions where the mains is de-staged and at shut down). The FSVs also prevent combustion chamber gases entering the respective manifolds if the downstream pressure exceeds a manifold pressure. By varying the fuel split between the manifolds, staging control of the engine can be performed.

In more detail, the staging system 130 has a fuel flow splitting valve (FFSV) 134, which receives the metered fuel flow from a hydromechanical unit (HMU) at pressure P_{fmu}. A spool is slidable within the FFSV under the control of a servo-valve 135, the position of the spool determining the outgoing flow split between a pilot connection pipe 136 which delivers fuel to the pilot manifold segments 131a, b and a mains connection pipe 137 which delivers fuel to the mains manifold 132. The spool can be positioned so that the mains stage is deselected, with the entire metered flow going to the pilot stage. A position sensor 138 provides feedback on the position of the spool to an engine electronic controller (EEC), which in turn controls staging by control of the servo-valve.

Between the FFSV 134 and the second pilot manifold segment 131b, the pilot connection pipe 136 communicates with a lean blow out protection valve 150 which controls communication between the pilot connection pipe 136 and the second pilot manifold segment 131b. The lean blow out protection valve is spring biased towards an open position. A solenoid operated control valve 152 is operable to apply a control pressure to the valve member of the lean blow out protection valve to move it against the action of the spring so that the valve is biased to a closed position, restricting the communication between the pilot connection pipe 136 and the second pilot manifold segment 131b, when required. Accordingly, if there is only a pilot delivery of fuel to the engine and there is a concern that a lean blow out condition may occur, the lean blow out protection valve 150 can be closed by appropriate control of the solenoid operated control valve 152, with the result that fuel delivery to the second pilot manifold segment 131b is restricted, whilst that to the first pilot manifold segment 131a is increased. Adequate pilot delivery through the reduced number of injectors fed by manifold segment 131a can therefore be assured, resulting in a reduced risk of a lean blow-out condition occurring.

The staging system 130 also has a recirculation line to provide the mains manifold 132 with a cooling flow of fuel when the mains manifold is deselected. The recirculation line has a delivery section including a delivery pipe 141 which receives the cooling flow from a fuel recirculating control valve (FRCV) 142, and a recirculation manifold 143 into which the delivery pipe feeds the cooling flow. The recirculation manifold has feeds which introduce the cooling flow from the recirculation manifold to the mains manifold via connections to the feeds from the mains manifold to the mains FSVs 140.

In addition, the recirculation line has a return section which collects the returning cooling flow from the mains manifold 132. The return section is formed by a portion of the mains connection pipe 137 and a branch pipe 144 from the mains connection pipe, the branch pipe extending to a recirculating flow return valve (RFRV) 145 from whence the cooling flow exits the recirculation line.

The cooling flow for the recirculation line is obtained from the HMU at a pressure HP_{f} via a cooling flow orifice (CFO) 146. On leaving the RFRV 145 via a pressure raising orifice (PRO) 147, the cooling flow is returned to the pumping unit for re-pressurisation by the HP pumping stage. A check valve 148 accommodates expansion of fuel trapped in the pilot and mains system during shutdown when the fuel expands due to combustor casing heat soak back. The check valve can be set to a pressure which prevents fuel boiling in the manifolds. The FRCV 142 and the RFRV 145 are operated under the control of the EEC. The HMU also supplies fuel at pressure HP_{f} for operation of the servo-valve 135, the RFRV 145, and the lean blow out protection valve 150.

When mains is staged in, a cooling flow is also directed through the recirculation manifold 143 to avoid coking therein. More particularly a small bypass flow is extracted from the HMU's metered fuel flow at pressure P_{fmu}. The bypass flow is sent via a flow washed filter 149 to a separate inlet of the FRCV 142, and thence through the delivery pipe 141 to the recirculation manifold 143. The bypass flow exits the recirculation manifold to rejoin the mains fuel flow at the injectors 133.

However, a problem with such a system is how to accommodate a mains FSV 140 failing to an open condition. In pilot-only operation, when cooling flow is passing through the recirculation manifold 143 and the mains manifold 132, such a failure can result in the cooling flow passing through the failed open FSV through one injector into the combustor, causing a hot streak which may lead to nozzle and turbine damage. In pilot and mains operation, such a failure can produce a drop in mains manifold pressure which causes other mains FSVs to close. A possible outcome is again that a high proportion of the total mains flow passes through the failed open FSV to one injector, causing a hot streak leading to nozzle and turbine damage.

In principle, such failure modes can be detected by appropriate thermocouple arrangements, e.g. to detect hot streaks. However, temperature measurement devices of this type can themselves have reliability issues.

Further, the problem of mains FSV failure can be exacerbated by system arrangements used to prevent combustion chamber gas ingress through the fuel injectors 133 during pilot only operation. Whilst the impact of such gas ingress is generally non-hazardous, it can lead to hot gas-induced degradation of FSV seals. Degraded FSV sealing can in turn lead to dribbling of fuel into de-staged nozzles, resulting in component blockage due to coking. For example, the system may be modified to make orifice 147 variable under servo-valve control so that the deselected mains manifold pressure can be controlled to maintain it at a level below that required to crack open the mains FSVs 140 but above combustion chamber pressure in order to prevent ingestion of hot combustion chamber gases past the FSV seals. A disadvantage of such an arrangement is that in the event of a mains FSV 140 failing open, the system may try to maintain manifold pressure above combustion chamber gas pressure (which can be taken to be approximately the same as the measured engine parameter P30—the high pressure compressor outlet pressure), and thus may react by delivering more flow to the fuel injectors. This further increases the risk of reducing nozzle and turbine life.

### SUMMARY

It would be desirable to address these problems.

Accordingly, in a first aspect, the present invention provides a fuel supply system for fuel injectors of a multi-stage combustor of a gas turbine engine, the fuel supply system including:
a metering and splitting arrangement which receives a total fuel flow and controllably meters and splits the received total fuel flow into metered pilot and mains flows for injecting respectively at pilot and mains fuel discharge orifices of the injectors to perform staging control of the combustor; and
pilot and mains fuel distribution pipeworks respectively distributing fuel from the metering and splitting arrangement to the pilot and mains discharge orifices;
wherein the metering and splitting arrangement is operable to select the pilot distribution pipework and deselect the mains distribution pipework for pilot-only operation in which there is a pilot supply to the combustor but no mains supply to the combustor from the injectors, and is operable to select both the pilot and mains distribution pipeworks for pilot and mains operation in which there are pilot and mains supplies to the combustor from the injectors;
wherein the fuel supply system further includes an ecology valve having a piston chamber and a piston slidably movable in the chamber between de-prime and re-prime positions, the chamber forming a fuel sink to one side of the piston which increases in volume when the piston moves to its de-prime position and reduces in volume when the piston moves to its re-prime position;
wherein the fuel supply system further includes an actuator for actuating the piston; and
wherein the ecology valve is fluidly connected to the mains fuel distribution pipework such that for pilot-only operation the actuator moves the piston to its de-prime position to remove the mains fuel from the injectors through the mains fuel distribution pipework and into the fuel sink, and such that for pilot and mains operation the actuator moves the piston to its re-prime position to refill the injectors with mains fuel from the fuel sink.

Thus in contrast to the system shown in FIG. 1, by de-priming the mains path in the injectors (removing mains fuel) when mains is de-staged and re-priming the mains path in the injectors (refilling with mains fuel) when mains is staged in, it becomes possible to perform staging control of a multi-stage combustor without a recirculating cooling flow to the mains manifold during pilot-only operation and without fuel scheduling valves in the mains fuel passages of the injectors. In particular, the ecology valve and actuator can be located in a relatively benign environment away from the injectors. Thus many of the problems indicated above can be avoided whilst enabling a simplified system (e.g. by removing mains FSVs and cooling recirculation architecture) with associated mass, cost and reliability benefits. Moreover, the use of the fuel sink can help to provide a fast and accurate re-priming capability.

The system also allows the injectors to have no pilot FSVs. These are not needed as the pilot supply flows continuously from the pilot fuel discharge orifices during normal operation, and can be reverse purged at shut down to prevent any leakage into the injectors and combustor. The reverse purge can be achieved, for example, by providing a manifold drain valve under the action of combustion chamber gas pressure. Removal of the pilot FSVs is a further simplification with cost, mass and reliability benefits. It also eliminates any potentially hazardous failure modes associated with flow maldistribution and subsequent turbine torching which can occur as a result of a pilot FSV seizing in an open position.

In a second aspect, the present invention provides a gas turbine engine having a multi-stage combustor and the fuel supply system according to the first aspect for supplying fuel to and performing staging control in respect of pilot and mains fuel discharge orifices of fuel injectors of the combustor.

The gas turbine engine may further have a pumping unit to supply the fuel flow to the metering and splitting arrangement of the fuel supply system.

The fuel injectors may be without fuel scheduling valves in respect of their mains discharge orifices. Each fuel injector may, however, have a respective weight distribution valve for its mains discharge orifice. The weight distribution valves can help to eliminate gravitational head effects between the injectors.

Optional features of the invention will now be set out. These are applicable singly or in any combination with any aspect of the invention.

The pilot fuel distribution pipework may include a pilot fuel manifold distributing fuel from the metering and splitting arrangement to the pilot discharge orifices. The pilot manifold may include a segment restrictable by a lean blow out protection valve to decrease the proportion of the pilot fuel flow delivered to the injectors fed by the segment relative to the pilot fuel flow delivered to the remaining injectors of the combustor.

The mains fuel distribution pipework may include a mains fuel manifold distributing fuel from the metering and splitting arrangement to the mains discharge orifices.

The metering and splitting arrangement may typically also be configured to fluidly isolate the mains fuel distribution pipework from the received total fuel flow and the pilot supply during pilot-only operation. In this way fuel leakage to the mains fuel distribution pipework and subsequently into mains fuel passageways and the mains discharge orifices of the injectors can be avoided, reducing the risk of injector coking during pilot-only operation.

The metering and splitting arrangement may include: a total metering valve (for example housed in an HMU) which receives and controllably meters the total fuel flow, and a splitting sub-arrangement which receives the total metered flow from the total metering valve and controllably splits the total metered flow into the pilot and mains flows. For example, the splitting sub-arrangement can be a fuel flow splitting valve or a set of valves providing a splitting function. As another example, the splitting sub-arrangement can be: a secondary metering valve, a fuel line extending between the secondary metering valve and a first one of the pilot and mains fuel distribution pipeworks, and a spill valve which is operable to control a pressure drop across the secondary metering valve by diverting a controlled portion of the total metered flow in the fuel line to the other of the pilot and mains fuel distribution pipeworks. In the case that the fuel line extends between the secondary metering valve and the pilot fuel distribution pipework, the diverted controlled portion forms the mains flow.

More particularly, by controlling the secondary metering valve pressure drop and valve position (e.g. under closed loop control achieved via a servovalve and position sensor), it is possible to set a pilot flow, the mains flow being the difference between total metered flow and pilot metered flow. In the case that the fuel line extends between the metering valve and the mains fuel distribution pipework, the diverted controlled portion forms the pilot flow. Another option, however, is for the metering and splitting arrangement to include: a pilot metering valve which receives and controllably meters a portion of the fuel flow for onward flow to the pilot distribution pipework, and a mains metering valve in parallel to the pilot metering valve, the mains metering valve receiving and controllably metering a different portion of the fuel flow for onward flow to the mains distribution pipework, wherein the relative values of the fuel flows controllably metered by the pilot and mains metering valves determine the staging control split of the pilot and mains flows. The pilot and mains metering valves can be in a single HMU or separate HMUs.

A pumping unit which supplies the fuel flow to the metering and splitting arrangement of the fuel supply system may have a low pressure pumping stage and high pressure pumping stage arranged in flow series. The low pressure pumping stage can be a centrifugal pump, and the high pressure pumping stage can be a positive displacement pump (e.g. one more gear pumps). However, when the metering and splitting arrangement includes a mains metering valve in parallel to a pilot metering valve, the pumping unit may have dedicated and respective high pressure pumping stages for these two metering valves.

The fuel supply system may further have a controller to control the metering and splitting arrangement and the actuator. For example, the controller can be an element of an engine electronic controller (EEC).

Moving the ecology valve piston to its de-prime position may also remove mains fuel from the mains fuel manifold, and moving the piston to its re-prime position may refill the mains fuel manifold with mains fuel. Typically the more fuel is removed, the longer time is required for refilling. However, in general, enough fuel should be removed so as to effectively remove a risk of fuel egress into the injectors, causing coking.

The actuator can be pneumatically, hydraulically (e.g. fuel-draulically), mechanically, electrically or electro-mechanically controlled. An electro-mechanical actuator may be a rotary to linear actuator (such as a motor and ball screw actuator or a motor and rack and pinion actuator) or a linear to linear actuator.

For example, an electro-mechanical actuator may be operable in one direction to drive the piston to its de-prime position and be operable in the opposite direction to drive the piston to its re-prime position.

As another example, the actuator may be a positive displacement pump (e.g. a gear pump or a piston pump) which is operable in one direction to draw fuel from the mains fuel distribution pipework and send it into the fuel sink, thereby de-priming the mains distribution pipework prior to pilot-only operation, and is operable in the opposite direction to send fuel from the fuel sink and re-prime the mains fuel distribution pipework prior to pilot and mains operation. Conveniently, the positive displacement pump may be electrically powered. The ecology valve piston may be spring biased towards its de-prime position. Thus, in the unlikely event of a control failure of the ecology valve, the piston can default to a safe de-prime position, maintaining pilot-only operation to avoid flameout.

When the actuator is a positive displacement pump, the ecology valve may be positioned between the positive displacement pump and the mains fuel distribution pipework. A variable volume control chamber can then be formed by the piston chamber between the pump and the ecology valve piston with the fuel sink on the opposite side of the piston. The positive displacement pump can then pump fuel from the control chamber, e.g. to a low pressure source, prior to pilot-only operation to move the piston to its de-prime position, and the positive displacement pump can pump fuel, e.g. from low pressure source, into the control chamber prior to pilot and mains operation to move the piston to its re-prime position. Piston displacement in either direction moves fuel between the fuel sink and the mains fuel distribution pipework to re-prime/de-prime the injectors. Alternatively, however, the positive displacement pump may be positioned between the ecology valve and the mains fuel distribution pipework. The opposite side of the piston to the fuel sink can be connected to a high or low pressure. The positive displacement pump can then pump fuel from the mains fuel distribution pipework into the fuel sink prior to pilot-only operation, moving the piston to its de-prime position and de-priming the injectors, and the positive displacement pump can pump fuel from the fuel sink into the mains fuel distribution pipework prior to pilot and mains operation, moving the piston to its re-prime position and re-priming the injectors.

The ecology valve may have a position sensor which senses the position of the piston. The position sensor can then send signals, e.g. to a suitable controller such as an EEC, to switch off the actuator when the piston reaches its de-prime and/or re-prime positions. More generally, however, the signals also allow refilling failure to be monitored, e.g. by an EEC.

The ecology valve may have a latching port which can be opened/closed as the piston moves to admit relatively high pressure fuel into the piston chamber on the opposite side of the piston to the fuel sink to latch the piston in its re-prime position. When the actuator is a positive displacement pump, the high pressure fuel can thereby latch the piston in its re-prime position when the positive displacement pump is switched off. The port can be open/closed merely by the movement of the piston, i.e. the port can be blocked off when the piston is moved to its de-prime position. However, another option is for a latching pressure signal to be provided by a separate servovalve or similar device. The port can then be opened/closed by the pressure signal rather than by movement of the piston.

### BRIEF DESCRIPTION OF THE DRAWINGS

Embodiments of the invention will now be described by way of example with reference to the accompanying drawings in which:

FIG. 1 shows schematically a combustion staging system for a gas turbine engine in pilot and mains operation mode;

FIG. 2 shows a longitudinal cross-section through a ducted fan gas turbine engine;

FIG. 3 shows schematically a pump system and a fuel supply system for fuel injectors of a multi-stage combustor of the gas turbine engine with the fuel supply system providing pilot-only operation;

FIG. 4 shows schematically the pump system and the fuel supply system of FIG. 3 but with the fuel supply system providing pilot and mains operation;

FIG. 5 shows schematically the pump system and a variant of the fuel supply system with the fuel supply system providing pilot and mains operation;

FIG. 6 shows schematically the pump system and a further variant of the fuel supply system with the fuel supply system providing pilot-only operation;

FIG. 7 shows schematically the pump system and the fuel supply system of FIG. 6 but with the fuel supply system providing pilot and mains operation;

FIG. 8 shows schematically the pump system and a further variant of the fuel supply system with the fuel supply system providing pilot-only operation;

FIG. 9 shows schematically an overview of a variant configuration with parallel pilot and mains metering paths from separate HMUs, and an ecology system on the mains path for mains manifold de-priming/re-priming;

FIG. 10 shows schematically a configuration similar to that of FIG. 9 but also with separate HP pumping stages for the two paths and independent and respective spill controls; and

FIG. 11 shows schematically an overview of a further variant configuration with parallel pilot and mains metering paths from a single HMU, and an ecology system on the mains path for mains manifold de-priming/re-priming.

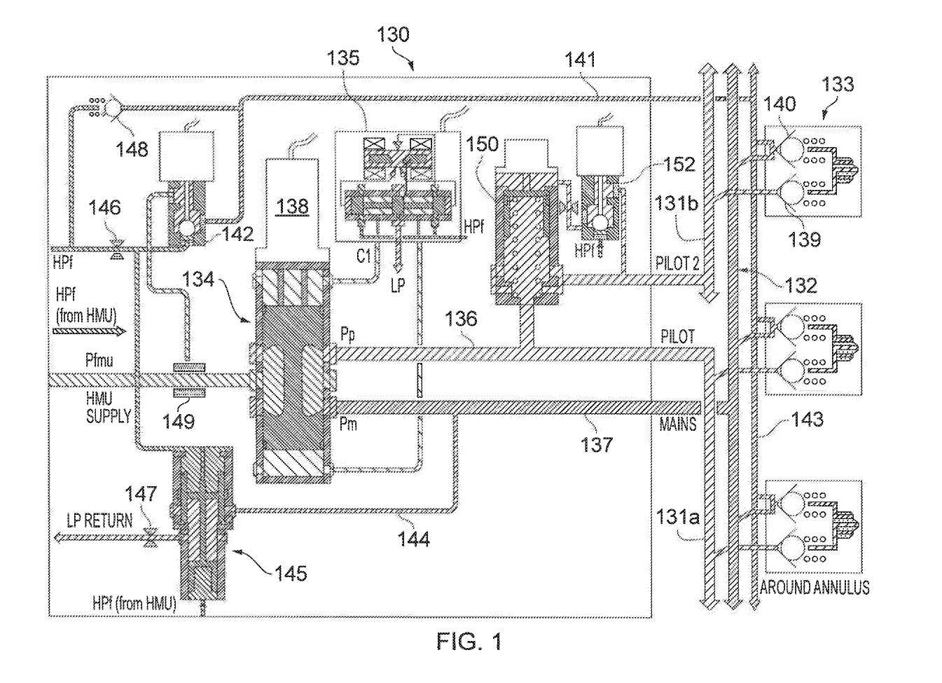

### DETAILED DESCRIPTION AND FURTHER OPTIONAL FEATURES

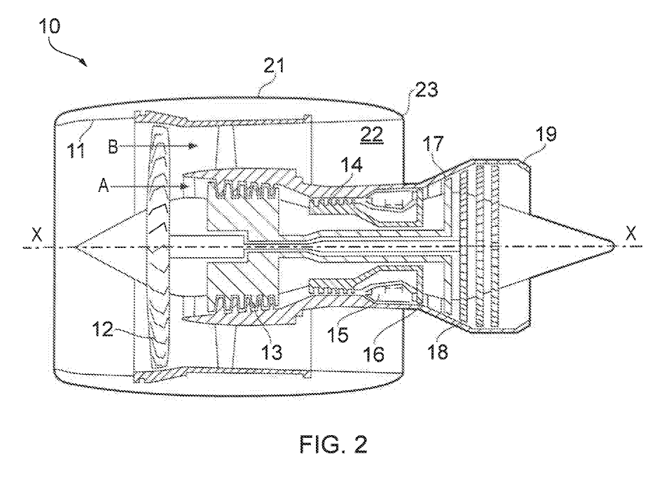

With reference to FIG. 2, a ducted fan gas turbine engine incorporating the invention is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate-pressure compressor 13 and a second air flow B which passes through the bypass duct 22 to provide propulsive thrust. The intermediate-pressure compressor 13 compresses the air flow A directed into it before delivering that air to the high-pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate-pressure compressors 14, 13 and the fan 12 by suitable interconnecting shafts.

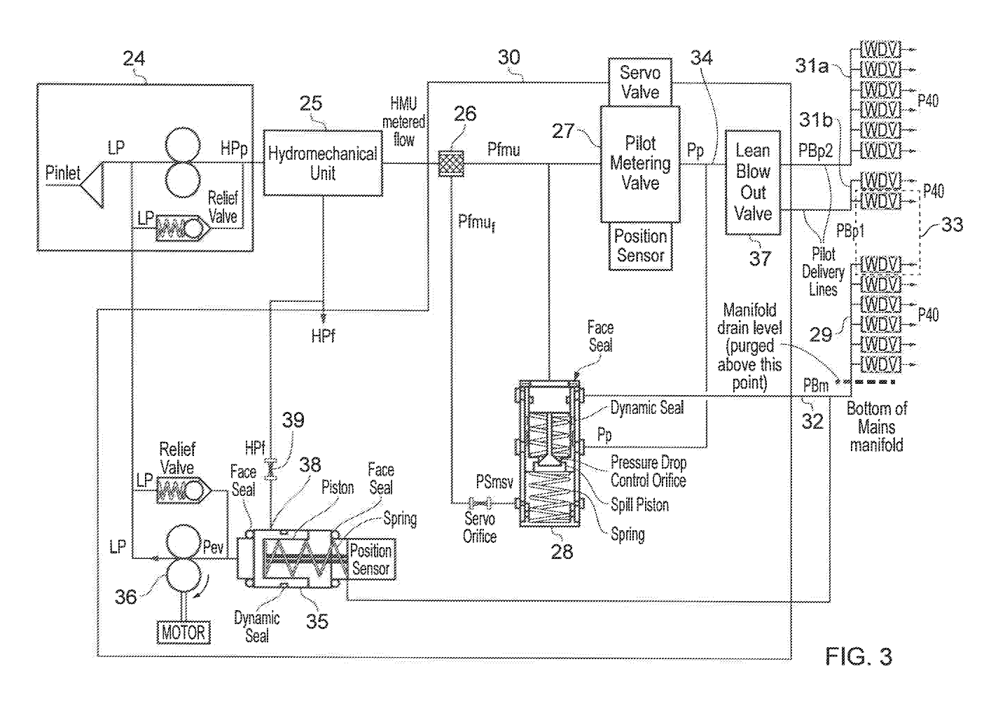

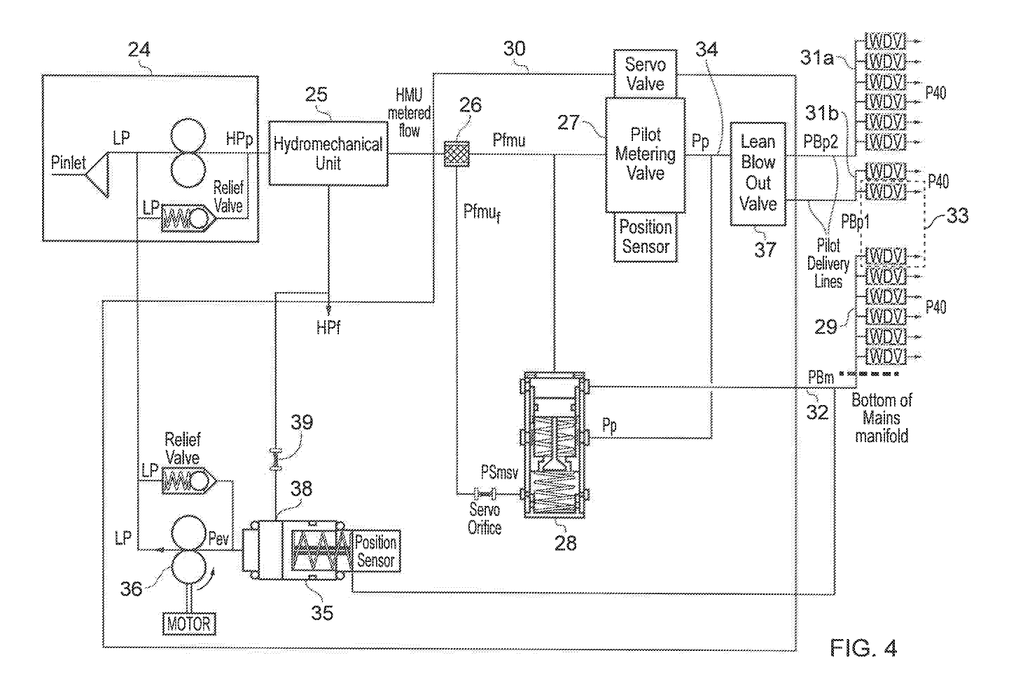

The combustion equipment 15 of the engine 10 includes a multi-stage combustor. FIGS. 3 and 4 show schematically a pump system and a fuel supply system for fuel injectors of the multi-stage combustor. In FIG. 3 the fuel supply system is shown in pilot-only operation with mains supply off and the mains fuel passages of the injectors and the connecting mains manifold de-primed. In FIG. 4 the fuel supply system is shown in pilot and mains operation with the mains fuel passages and mains manifold re-primed and mains supply on.

The pump system 24 comprises typically a low pressure (LP) pumping stage which draws fuel from a fuel tank of the aircraft and supplies the fuel at boosted pressure to the inlet of a high pressure (HP) pumping stage. The LP stage typically comprises a centrifugal impeller pump while the HP pumping stage may comprise one or more positive displacement pumps, e.g. in the form of twin pinion gear pumps. The LP and HP stages are typically connected to a common drive input, which is driven by the engine HP or IP shaft via an engine accessory gearbox.

A fuel supply system accepts fuel from the HP pumping stage for feeding to the combustor. This system typically has a hydro-mechanical unit (HMU) 25 which performs total metering and comprises a fuel metering valve operable to control the rate at which fuel is allowed to flow to the combustor. The HMU further typically comprises: a pressure drop control arrangement (such as a spill valve and a pressure drop control valve) which is operable to maintain a substantially constant pressure drop across the metering valve, and a pressure raising and shut-off valve at the fuel exit of the HMU which ensures that a predetermined minimum pressure level is maintained upstream thereof for correct operation of any fuel pressure operated auxiliary devices (such as variable inlet guide vane or variable stator vane actuators) that receive fuel under pressure from the HMU. Further details of such an HMU are described in EP 2339147 A (hereby incorporated by reference).

An engine electronic controller (EEC) commands the HMU fuel metering valve to supply fuel to the combustor at a given flow rate. The metered fuel flow leaves the HMU and arrives at a staging system 30 of the fuel supply system.

The staging system 30 splits the fuel into two flows: one for a pilot flow along pilot fuel distribution pipework 34 to first 31a and second 31b segments of a pilot manifold and the other for a mains flow along mains fuel distribution pipework 32 to mains manifold 29. Each fuel injector 33 of the combustor of the engine has a fuel spray nozzle (FSN) containing a pilot (primary) discharge orifice and a mains (secondary) discharge orifice. The injectors are split into two groups. The pilot discharge orifices of the FSNs of the injectors of one group are connected to the first pilot manifold segment 31a, while pilot discharge orifices of the FSNs of the injectors of the other group are connected to the second pilot manifold segment 31b. The mains flow from the mains manifold feeds the mains discharge orifices of the FSNs of both groups of the fuel injectors. The pilot and mains discharge orifices may have respective weight distribution valves (WDVs) to reduce gravitational head effects between the injectors.

On entry into the staging system 30, the metered fuel flow first passes through a flow washed filter (FWF) 26, thereby providing scouring flow for the filter. Servo flows to various internal servo orifices and control valves are taken through a fine mesh of the FWF.

A pilot (secondary) metering valve (PMV) 27 meters the total pilot flow to the pilot fuel distribution pipework 34, thereby controlling the overall pilot/mains flow split. This is achieved by modulating the PMV to vary the opening of a metering port. A typical arrangement is to have a metering piston moving within a sleeve of the PMV to vary the opening of a metering profile cut into the sleeve. The piston can be actuated by a servo-valve in response to a demand signal from the EEC, with valve position feedback provided by a position sensor.

The pressure drop across the metering profile is regulated to a nominally constant value so that the metered pilot flow is principally a function of the PMV piston position. A mains spill valve 28 controls the pressure drop across the PMV by spilling the portion of total metered flow not required by the pilot discharge orifices of the injectors to the mains fuel distribution pipework 32. For example, an inner piston of the mains spill valve senses the PMV pressure drop and adjusts a pressure drop control orifice of the mains spill valve (via a poppet valve) so that an outer spill piston of the mains spill valve moves to maintain a constant pressure drop across the PMV.

Downstream of the PMV, the total pilot flow in the pilot fuel distribution pipework 34 can be split between the first 31a and second 31b segments of the pilot manifold. A lean blow out protection valve 37 and e.g. a solenoid-operated control valve (not shown) may be located between the pilot fuel distribution pipework and the first pilot manifold segment 31a. When activated, the lean blow out protection valve can restrict the portion of pilot fuel flow passing to the FSNs connected to the first manifold segment 31a so that a higher proportion of the total pilot flow passes to a reduced number of FSNs connected to the second manifold segment 31b, ensuring that the latter receive sufficient fuel to avoid lean blow out. The lean blow out protection valve and the associated twin segment pilot manifold arrangement are optional features; the total pilot flow can be fed to a single manifold (no lean blow out protection valve required) or indeed multiple pilot manifolds via multiple valve arrangements.

Under pilot-only operation (FIG. 3), the PMV 27 is driven wide open, causing the pressure drop across the PMV to decrease. This is sensed by the mains spill valve 28, which responds by moving to close off the flow to the mains fuel distribution pipework 32, thereby deselecting the mains manifold 29 and the mains discharge orifices of the injectors 33. The mains spill valve provides a drip tight seal between the upstream PMV and the downstream mains fuel distribution pipework. This can be achieved via a face seal, which contacts the end of the mains spill valve piston and a further dynamic seal on the piston itself. Drip tight sealing prevents ingress of fuel into the mains manifold and subsequently into the injectors, and thus helps to prevent coking of the small mains fuel passages of the injectors. Such coking can increase injector-to-Injector fuel maldistribution and reduce overall injector life.

The staging system 30 has an ecology valve 35 comprising a piston chamber and a piston slidably movable in the piston chamber between de-prime and re-prime positions. The piston chamber forms a fuel sink in the form of a spring chamber to one side of the piston and a control chamber on the other side of the piston. This sink increases in volume when the piston moves to its de-prime position and reduces in volume when the piston moves to its re-prime position. On closing off the mains supply in pilot-only operation, an ecology pump 36 (illustrated here as a gear pump, but it could be a different type of positive displacement pump, such as a piston pump), which is driven by an electric motor in a reverse sense direction, drains a fixed volume of fuel from the mains fuel distribution pipework 32 into the fuel sink. More particularly, the ecology pump draws fuel from a variable volume control (non-spring) chamber of the ecology valve on the opposite side of the piston to the spring chamber (fuel sink), so that the pressure in the valve spring chamber falls to the combustion chamber pressure (P40) and the pressure in the control chamber (Pev) rises to a level above P40, which is set by the ecology valve force balance. This is insufficient to open an ecology pump relief valve, which remains closed throughout the de-priming process.

The flow drawn by the ecology pump 36 and returned to LP causes displacement of the piston of the ecology valve 35 to the left (as illustrated in FIG. 3), closing off a high pressure line from a latching port 38 of the ecology valve. As the piston moves it draws the fixed volume of fuel from the mains fuel distribution pipework 32 into the spring chamber (sink) so that (i) the injectors 33 are fully emptied of mains fuel, and (ii) the mains manifold 29 is emptied sufficiently to avoid any subsequent ingress of fuel into the mains passages of the injectors should the remaining fuel in the mains fuel distribution pipework/manifold expand under temperature during pilot-only operation or be displaced during aircraft manoeuvres.

When the piston of the ecology valve 35 reaches its final de-prime position (left hand hard stop), the pressure (Pev) falls towards vapour pressure. A position sensor on the ecology valve provides an indication to the EEC that the valve has reached the hard stop. Once this is confirmed, the ecology pump can be de-powered to reduce power consumption and to avoid heat generation. The pressure Pev then rises to LP and the ecology valve spring, which is sized to hold the valve closed against the maximum LP-P40 pressure, maintains the piston in this position until the next time that mains flow is required. A combination of, for example, a left hand face seal and dynamic piston seal within the ecology valve can create a drip tight seal across the valve. This prevents ingress of LP fuel into the mains manifold 29 when LP exceeds P40, as well as preventing ingress of hot combustion gas (P40) back into the fuel system at conditions where P40 exceeds LP.

When the system is shut down on the ground, but the aircraft tank pumps are left running for maintenance purposes, the spring of the ecology valve 35 can hold the piston at its final de-prime position against any LP pressure so that the mains manifold 29 does not refill. The shut-off valve in the HMU 25, along with seals in the PMV 27 and the mains spill valve 28 also prevent fuel ingress into the pilot manifold 31 and the mains manifold 29.

When mains flow is required (FIG. 4), the ecology pump 36 is powered by the electric motor in a forward sense to drive the piston of the ecology valve 35 to its final re-prime position (to the right as illustrated), thereby displacing fuel from the ecology valve spring chamber (sink) into the main fuel distribution pipework 32 to refill the mains manifold 29 and the mains passages of the injectors 33. Advantageously, the electric motor can accelerate the ecology pump quickly to provide a fast re-prime capability.

As the ecology pump 36 pumps fuel at LP from the inlet of the HP pumping stage of the pump system 24 into the non-spring chamber of the ecology valve 35, the pressure Pev in the non-spring chamber rises above LP to a level above P40, set by the valve force balance. This is insufficient to open the ecology pump relief valve, which remains closed as the piston moves. The movement of the piston to the right displaces the fixed volume of fuel in the spring chamber (sink) back into the main fuel distribution pipework 32 so that the mains manifold 29 and the mains passages of the injectors 33 become fully re-primed prior to the demand for mains flow. The mains discharge orifices WDVs limit any pre-leakage from the injectors.

The position sensor of the ecology valve 35 provides an indication that the piston has reached its right-hand stop (indicating that the injectors 33 are fully re-primed with mains fuel). The electric motor drive to the ecology pump 36 can then be switched off with the ecology pump relief valve cracking to prevent any over-pressurisation prior to the pump being switched off. The latching port 38 in the ecology valve opens as the piston reaches its right-hand stop. This admits HMU high pressure (HP) fuel to the control (non-spring) chamber of the ecology valve via a latching feed orifice 39. The HP fuel holds the piston in position once the ecology pump is de-powered. A second face seal at the right hand end of the valve, together with the piston dynamic seal can prevent leakage across the ecology valve to, or from, the mains fuel distribution pipework 32. Any parasitic leakage from HP to LP through the latching port is limited by the size of the latching feed orifice and the ecology pump itself.

Once re-priming indication is confirmed, the metering piston of the PMV 27 is commanded off its wide open stop, back towards a partially open condition at the correct opening for the demanded pilot flow. The resultant increase in PMV pressure drop is sensed by the mains spill valve 28, which opens to restore the correct PMV pressure drop and to simultaneously allow the correct mains flow to spill into the mains fuel distribution pipework 32.

Being able to displace a known fixed volume of fuel (set by the piston chamber diameter and piston travel of the ecology valve 35) during both de-priming and re-priming is particularly advantageous. This volume is sufficiently large so that (i) a full de-prime of the mains fuel from the injectors 33 and mains manifold 29 is achieved for pilot-only operation, (ii) in pilot-only operation, any expansion of residual fuel at high temperatures does not result in fuel ingress into the mains passages of the injectors, and (iii) in pilot-only operation, any aircraft manoeuvres do not result in flow spilling into the mains injector passageways. However, the volume is preferably as low as possible to minimise re-prime time, so that the engine can achieve acceleration performance requirements.

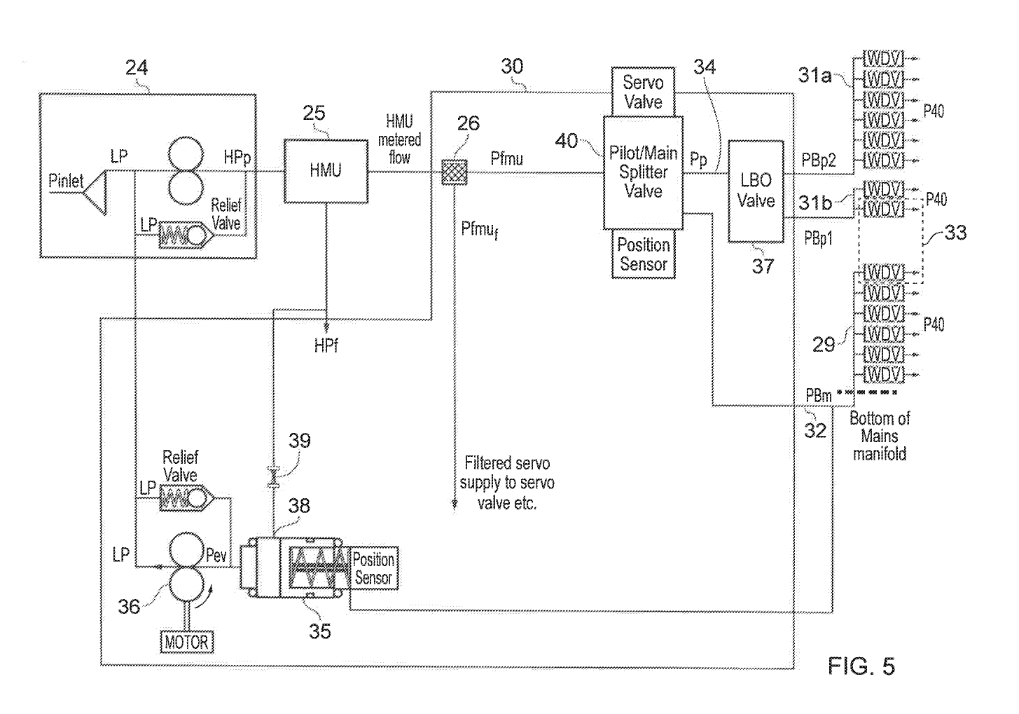

Many variants of the fuel supply system are possible. For example, the system shown in FIGS. 3 and 4 can be reconfigured to meter mains flow and spilling to pilot. As another example, the PMV/spill valve arrangement could be replaced by a splitter valve. Such a variant is shown schematically in FIG. 5 under pilot and mains operation. A fuel flow splitting valve (FFSV) 40, or any other suitably-arranged set of valves known to the skilled person and providing a splitting function, receives the metered fuel flow from the HMU 25. Typically, the FFSV has a slidable spool under the control of a servo-valve, the position of the spool determining the outgoing flow split between two outlets forming respectively the pilot flow and the mains flow. The spool can be positioned so that the mains stage is completely deselected, with the entire metered flow going to the pilot stage. A position sensor can provide a feedback signal indicating the position of the spool to the EEC, which in turn controls the staging split ratio by sending a signal to the servo-valve to drive the splitter valve to a demanded position. The FFSV includes a sealing arrangement for drip tight mains sealing during pilot-only operation.

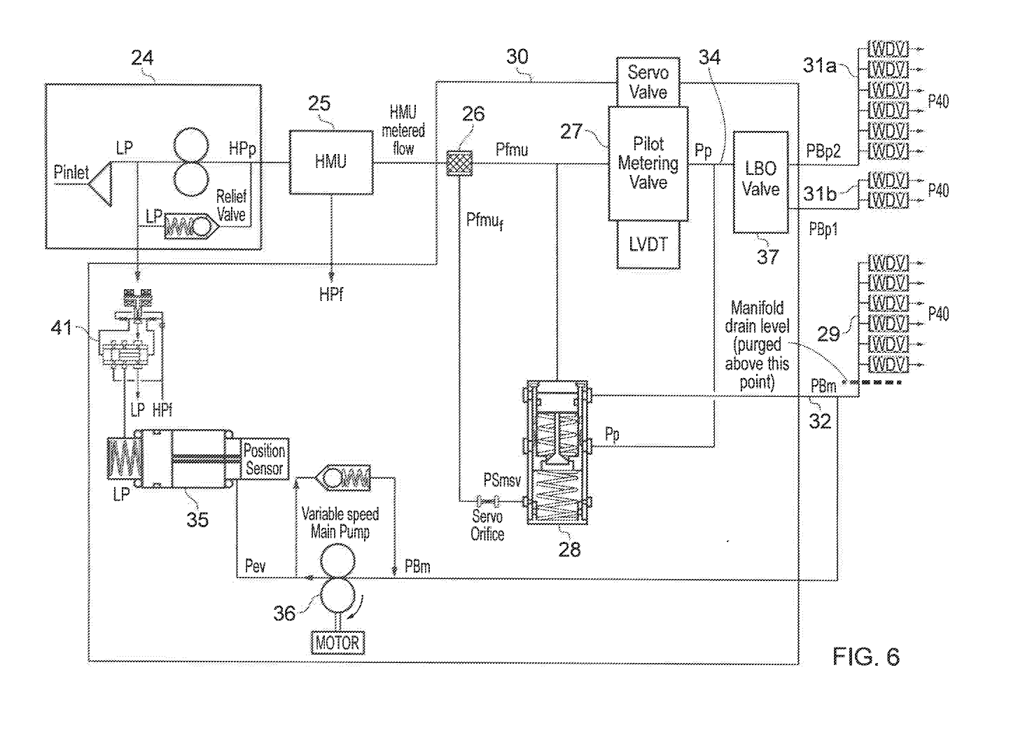

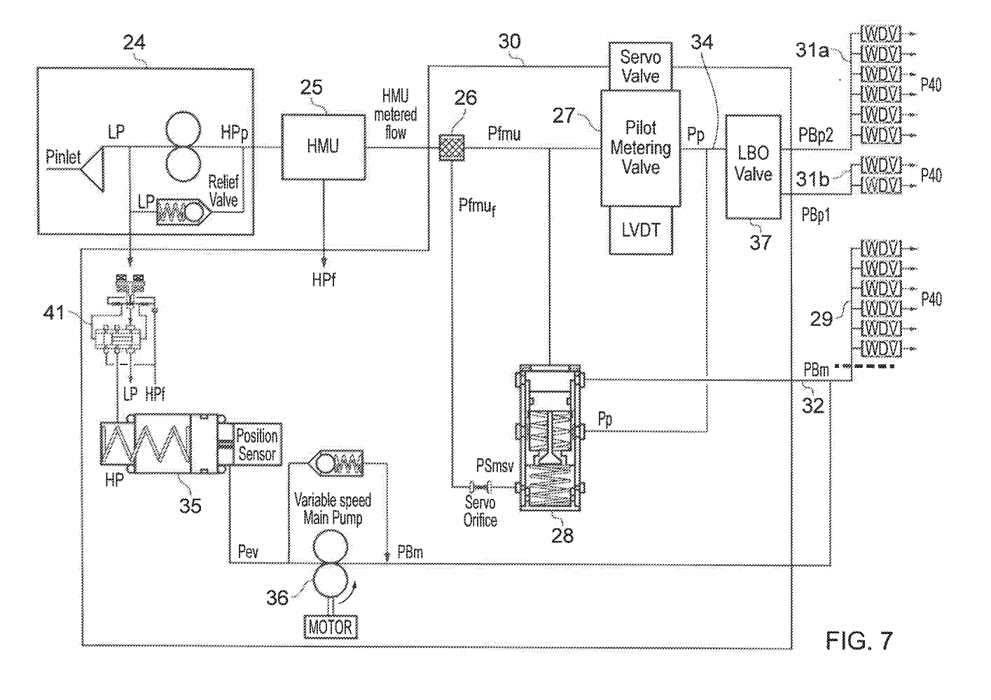

FIGS. 6 and 7 show schematically the pump system and a further variant of the fuel supply system under respectively pilot-only operation and pilot and mains operation. In this variant the ecology valve 35 is moved to the other side of the ecology pump 36, and an ecology latch 41 in the form servo-valve or similar device varies the pressure in the non-fuel sink chamber of the ecology valve to provide fuel-draulic latching of the valve. In FIG. 6 (pilot-only operation), the ecology pump and the ecology valve act in a similar manner to that previously described in respect of FIGS. 3 and 4 to de-prime the mains manifold 29 the mains passages of the injectors 33. The ecology valve is latched in position using the servo-valve 41 to port fuel at LP from the inlet to the HP pumping stage of the pump system 24 to the non-fuel sink chamber. The control (fuel sink) chamber on the other side of the piston is pressurised by the ecology pump, which is left running at a low speed/flow to spill flow through a low pressure relief valve once the ecology valve has moved to its de-prime (left-hand) position, as indicated by the ecology valve position sensor. The mains manifold 29 does not refill as there is fixed recirculating flow around the ecology pump.

In FIG. 7 (pilot and mains operation) the ecology pump 36 and ecology valve 35 combine to re-prime the mains manifold/injectors. More particularly, the piston of the ecology valve is fuel-draulically latched into its re-prime position by using the servo-valve 41 to feed HMU high pressure (HP) fuel to the non-fuel sink chamber. With the valve piston in this position, the ecology pump can be de-powered.

A potential benefit of this variant is a reduction in HP to LP parasitic leakage, which has an impact on main engine pump sizing. There is also potential to reference the latching servo-valve 41 to another low pressure sink instead of LP (e.g. atmosphere or low pressure pump inlet pressure (Pinlet)), as long as high pressure fuel leakage to such a sink via the servo-valve can be avoided.

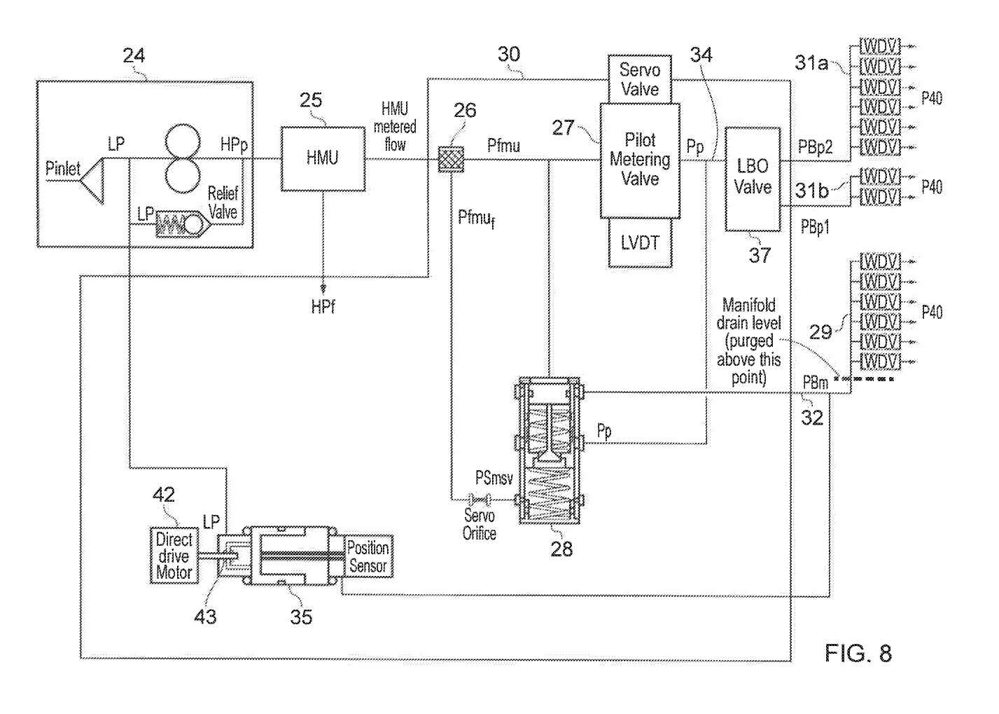

The staging system 30 can be re-configured to use a directly-driven ecology valve 35 to perform the de-priming/re-priming. One example is illustrated in FIG. 8 in which a stepper motor 42 is used to drive the ecology valve via e.g. a ball screw or rack and pinion 43. Potential benefits of this variant are that the directly-driven ecology valve requires no additional latching features, and that there are no additional HP to LP parasitic leakages

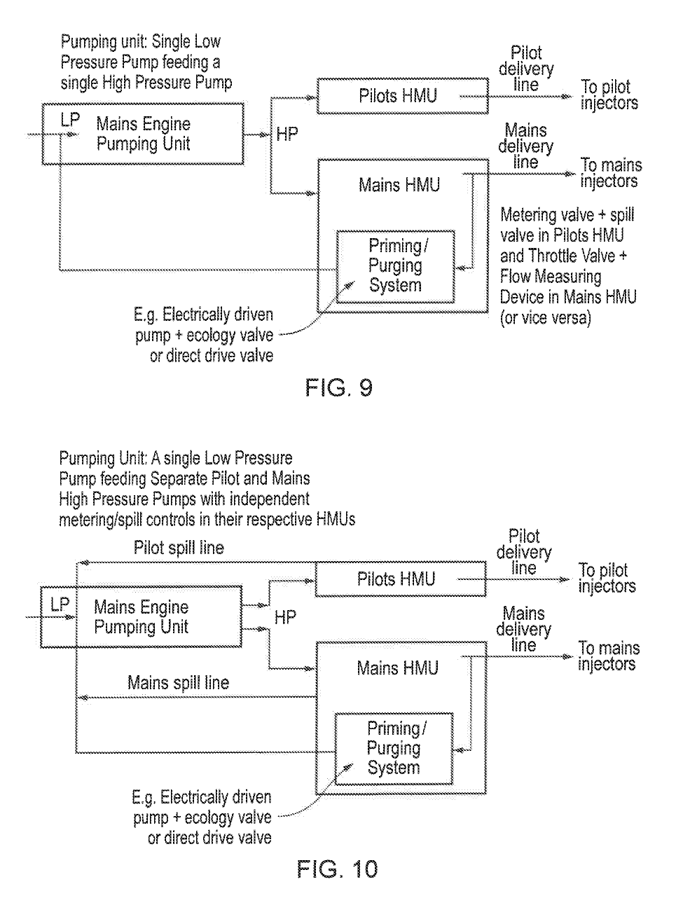

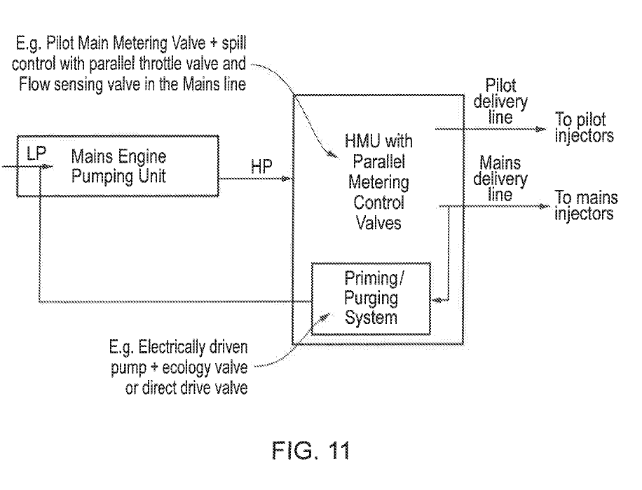

All the above systems have the HMU 25 acting upstream of and in series with the staging system 30 which controls the pilot/mains split. However, the fuel supply system can be reconfigured to a parallel arrangement whereby two parallel HMUs, or a single HMU with parallel metering paths, provide the total flow and pilot/mains split control. This is illustrated schematically in FIGS. 9 to 11 for three possible reconfigurations. FIG. 9 shows a system with parallel pilot and mains metering paths from separate HMUs, and an ecology system on the mains path for mains manifold de-priming/re-priming. FIG. 10 shows a system similar to that of FIG. 9 but also with separate HP pumping stages for the two paths and independent and respective spill controls. FIG. 11 shows a system with parallel pilot and mains metering paths from a single HMU, and an ecology system on the mains path for mains manifold de-priming/re-priming.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

What is claimed is:

1. A fuel supply system for fuel injectors of a multi-stage combustor of a gas turbine engine, the fuel supply system including:
a metering and splitting arrangement which receives a total fuel flow and controllably meters and splits the received total fuel flow into metered pilot and mains flows for injecting respectively at pilot and mains fuel discharge orifices of the injectors to perform staging control of the combustor; and
pilot and mains fuel distribution pipeworks respectively distributing fuel from the metering and splitting arrangement to the pilot and mains discharge orifices;
wherein the metering and splitting arrangement is operable to select the pilot distribution pipework and deselect the mains distribution pipework for pilot-only operation in which there is a pilot supply to the combustor but no mains supply to the combustor from the injectors, and is operable to select both the pilot and mains distribution pipeworks for pilot and mains operation in which there are pilot and mains supplies to the combustor from the injectors;
wherein the fuel supply system further includes an ecology valve having a piston chamber and a piston slidably movable in the chamber between de-prime and re-prime positions, the chamber forming a fuel sink to one side of the piston which increases in volume when the piston moves to its de-prime position and reduces in volume when the piston moves to its re-prime position;
wherein the fuel supply system further includes an actuator for actuating the piston; and
wherein the ecology valve is fluidly connected to the mains fuel distribution pipework such that for pilot-only operation the actuator moves the piston to its de-prime position to remove the mains fuel from the injectors through the mains fuel distribution pipework and into the fuel sink, and such that for pilot and mains operation the actuator moves the piston to its re-prime position to refill the injectors with mains fuel from the fuel sink.

2. A fuel supply system according to claim 1, wherein the metering and splitting arrangement is configured to fluidly isolate the mains fuel distribution pipework from the received total fuel flow and the pilot supply during pilot-only operation.

3. A fuel supply system according to claim 1, wherein the metering and splitting arrangement includes: a total metering valve which receives and controllably meters the total fuel flow, and a splitting sub-arrangement which receives the total metered flow from the total metering valve and controllably splits the total metered flow into the pilot and mains flows.

4. A fuel supply system according to claim 1, wherein the metering and splitting arrangement includes: a pilot metering valve which receives and controllably meters a portion of the fuel flow for onward flow to the pilot distribution pipework, and a mains metering valve in parallel to the pilot metering valve, the mains metering valve receiving and controllably metering a different portion of the fuel flow for onward flow to the mains distribution pipework, and wherein the relative values of the fuel flows controllably metered by the pilot and mains metering valves determine the staging control split of the pilot and mains flows.

5. A fuel supply system according to claim 1, wherein moving the piston to its de-prime position also removes mains fuel from the mains fuel manifold, and moving the piston to its re-prime position refills the mains fuel manifold with mains fuel.

6. A fuel supply system according to claim 1, wherein the actuator is a positive displacement pump which is operable in one direction to send fuel into the fuel sink from the mains fuel distribution pipework prior to pilot-only operation, and is operable in the opposite direction to send fuel from the fuel sink into the mains fuel distribution pipework prior to pilot and mains only operation.

7. A fuel system according to claim 6, wherein the positive displacement pump is electrically powered.

8. A fuel supply system according to claim 6, wherein the piston is spring biased towards its de-prime position.

9. A fuel system according to claim 6, wherein the ecology valve is positioned between the positive displacement pump and the mains fuel distribution pipework, and the piston chamber forms a variable volume control chamber on the opposite side of the piston to the fuel sink, the positive displacement pump pumping fuel from the control chamber prior to pilot-only operation to move the piston to its de-prime position, and the positive displacement pump pumping fuel into the control chamber prior to pilot and mains operation to move the piston to its re-prime position,

10. A fuel system according to claim 6, wherein the positive displacement pump is positioned between the ecology valve and the mains fuel distribution pipework, the positive displacement pump pumping fuel from the mains fuel distribution pipework into the fuel sink prior to pilot-only operation to move the piston to its de-prime position, and the positive displacement pump pumping fuel from the fuel sink into the mains fuel distribution pipework prior to pilot and mains operation to move the piston to its re-prime position,

11. A fuel system according to claim 1, wherein the actuator is an electro-mechanical actuator which is operable in one direction to drive the piston to its de-prime position and is operable in the opposite direction to drive the piston to its re-prime position.

12. A fuel system according to claim 1, wherein the ecology valve has a position sensor which senses the position of the piston, the position sensor sending signals to switch off the actuator when the piston reaches its de-prime and/or re-prime positions.

13. A fuel system according to claim 1, wherein the ecology valve has a latching port which admits relatively high pressure fuel into the piston chamber on the opposite side of the piston to the fuel sink to latch the piston in its re-prime position.

14. A gas turbine engine having a multi-stage combustor and the fuel supply system according to claim 1 for supplying fuel to and performing staging control in respect of pilot and mains fuel discharge orifices of fuel injectors of the combustor.
